(19) United States
(12) Patent Application Publication
(10) Pub. No.: US 2002/0113898 A1
(43) Pub. Date: Aug. 22, 2002

(54) PICTURE PROCESSING APPARATUS AND METHOD, AND RECORDING MEDIUM

(76) Inventor: SATOSHI MITSUHASHI, TOKYO (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/058,523

(22) Filed: Apr. 10, 1998

(30) Foreign Application Priority Data
Apr. 14, 1997 (JP) P09-095991

(51) Int. Cl. H04N 11/02; H04N 11/04; H04N 7/12

(52) U.S. Cl. 348/578; 375/240.17; 348/584

(57) ABSTRACT

A picture processing apparatus and method adapted to realize simplified exertion of special effects on any picture to apply a mosaic or the like thereto. The apparatus comprises a means for encoding the picture to generate encoded data, and a means for controlling the encoding means to exert special effects on the picture. A quantizer normally quantizes only a direct-current component of entire DCT coefficients per block of 8×8 pixels, while setting each of the other DCT coefficients to zero. In this case, the picture is given merely a single color per macro block of 16×16 pixels, so that the picture appears with a mosaic applied thereto. And in a recording medium, a program is recorded for enabling a computer to execute a special effect process according to the method of the invention. Thus, mosaic fade or the like can be performed simply by mere manipulation of the parameters of encoded data without the necessity of decoding even the pixel data of the raster image of such encoded data.

### BACKGROUND OF THE INVENTION

The present invention relates to a picture processing apparatus, a picture processing method and a recording medium, and more particularly to those adapted for simply exerting special effects on a picture when or after encoding the picture in conformity with the MPEG (Moving Picture Experts Group) standard or the like.

For exerting special effects on a picture by, for example, applying a mosaic thereto or gradually changing pictures from a pre-change scene to a post-change scene, it has been necessary heretofore to employ an exclusive device termed an effector.

However, considering that the effector is expensive and the processing thereof is complicated, great convenience is ensured if a low-cost device is available to attain simple exertion of special effects.

Recently, there is realized a computer-based nonlinear editing device where editing is performed after entire pictures are read and stored in a hard disk or the like. Since the pictures are huge in data quantity, the pictures are stored usually through compression encoding. Therefore, in exerting special effects on such compression-encoded pictures, it is necessary to decode the compression-encoded data to obtain pixel data of raster images.

However, as the data quantity of the pictures thus obtained by decoding is so huge, memories of great capacities and a long processing time are needed for exertion of special effects on such pictures. Further, the resultant pictures need to be compression-encoded again to consequently complicate the processing.

### SUMMARY OF THE INVENTION

It is therefore an object of the present invention to realize simplified exertion of special effects on any picture.

According to a first aspect of the present invention, there is provided a picture processing apparatus comprising a means for encoding the picture to generate encoded data thereof; and a means for controlling the encoding means in a manner to exert special effects on the picture.

According to a second aspect of the present invention, there is provided a picture processing method comprising a step of controlling an encoding means, which encodes a picture to generate encoded data thereof, in a manner to exert special effects on the picture.

According to a third aspect of the present invention, there is provided a recording medium wherein a program is recorded for enabling a computer to execute a special effect process by the method mentioned.

According to a fourth aspect of the present invention, there is provided a picture processing apparatus comprising a means for manipulating a predetermined parameter, which is included in the data obtained by encoding the picture, in a manner to exert special effects on the picture.

According to a fifth aspect of the present invention, there is provided a picture processing method comprising a step of manipulating a predetermined parameter, which is included in encoded data of the picture, in a manner to exert special effects on the picture.

And according to a sixth aspect of the present invention, there is provided a recording medium wherein a program is recorded for enabling a computer to execute a special effect process by the above method.

In the present invention, due to the existence of such a program, special effects can be simply exerted on any picture without the necessity of decoding even the pixel data of the raster image of the encoded data.

The above and other features and advantages of the present invention will become apparent from the following description which will be given with reference to the illustrative accompanying drawings.

### BRIEF DESCRIPTION OF THE DRAWINGS

FIG. 1 is a block diagram showing a structural example of an embodiment which represents a nonlinear editing apparatus where the present invention is applied;

FIG. 2 is a block diagram showing a structural example of the hardware of a compressor in the embodiment of FIG.1;

FIG. 3 is a block diagram showing a first functional structural example of the compressor in the embodiment of FIG. 1;

FIG. 4 is a block diagram showing a second functional structural example of the compressor in the embodiment of FIG. 1;

FIG. 5 shows DCT coefficients;

FIG. 6 is a block diagram showing a third functional structural example of the compressor in the embodiment of FIG. 1;

FIG. 7 shows a structural example of a GOP;

FIG. 8 shows an example of random mosaic fade;

FIG. 9 is a block diagram showing a fourth functional structural example of the compressor in the embodiment of FIG. 1; and

FIG. 10 is a flowchart for explaining a processing routine executed to exert special effects on encoded data.

### DESCRIPTION OF THE PREFERRED EMBODIMENTS

Hereinafter some preferred embodiments of the present invention will be described in detail with reference to the accompanying drawings.

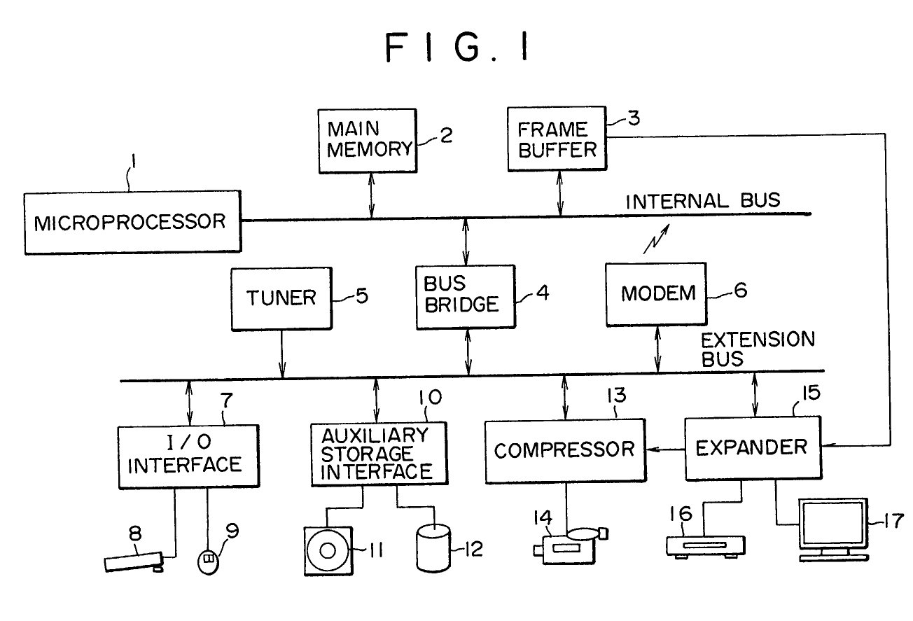

FIG. 1 shows a structural example of an embodiment which represents a nonlinear editing apparatus where the present invention is applied.

This nonlinear editing apparatus is constituted on the basis of, for example, a computer. More specifically, under control of an operating system recorded in a hard disk 12, a microprocessor 1 (control means, manipulating means) executes an application program recorded in the same hard disk 12, thereby editing video and audio data and further executing other predetermined processes such as exertion of special effects on pictures. A main memory 2 is used for storing the programs executed by the microprocessor 1 and also some data required for operating the microprocessor 1. A frame buffer 3 consists of, e.g., a DRAM (Dynamic Random Access Memory) or the like and serves to store pictures and so forth generated by the microprocessor 1. And a bus bridge 4 controls transfer of data between an internal bus and an extension bus such as PCI (Peripheral Component Interconnect) local bus.

Such microprocessor 1, main memory 2, frame buffer 3 and bus bridge 4 mentioned above are connected mutually via the internal bus, while the remaining blocks are connected mutually via the extension bus. However, the bus bridge 4 is connected to both of the internal bus and the extension bus.

A tuner 5 receives, for example, television broadcast signal transmitted by means of ground waves, satellite channel or CATV network. Any picture and so forth received by the tuner 5 can also be treated as subjects to be edited or processed with special effects. A modem 6 controls communications performed via telephone circuits. In the modem 6, any picture and so forth received via the internet can also be treated as subjects to be edited or processed with special effects, and it is further possible to transmit the edited or effected pictures to any external apparatus or line.

An I/O (Input/Output) interface 7 outputs a manipulation signal corresponding to a manipulation of a keyboard 8 or a mouse 9. The keyboard 8 is manipulated when inputting predetermined data or command, while the mouse 9 is manipulated when shifting a cursor on a display (computer display) 17 or when indicating a desired position.

An auxiliary storage interface 10 controls an operation of writing data in or reading the same from a CD-R (Compact Disc Recordable) 11 or a hard disk (HD) 12. In the CD-R 11, edited or effected pictures for example are recorded. Meanwhile in the hard disk 12, there are stored an operating system and an application program for enabling the microprocessor 1 to execute a nonlinear editing process, a special effect process and so forth. Further in the hard disk 12, there are also stored pictures to be edited or processed with special effects, and the processed pictures as well.

A compressor 13 (encoding means) compresses and encodes input video and audio data in conformity with the MPEG standard for example. The compressor 13 is further capable of compressing data supplied via the extension bus, data supplied via an expander 15, or data supplied from an external apparatus such as a video camera 14.

In the video camera 14, audio and video data to be edited are recorded. The compressor 13 has an interface relative to the video camera 14, so that any video and audio data recorded in the video camera 14 can be inputted to the compressor 13.

The expander 15 decodes (expands) the encoded (compressed) data obtained from the compressor 13 and then outputs the decoded data. When necessary, the expander 15 overlays the decoded picture on the picture stored in the frame buffer 3 and outputs the same. In the embodiment of FIG. 1, supply of the picture data from the frame buffer 3 to the expander 15 is performed directly therebetween. However, it is also possible to perform such data supply via the internal bus, the bus bridge 4 and the extension bus. In this case, if the capability of the internal bus or the extension bus is low, the data may be retarded when the picture data are supplied from the frame buffer 3 to the expander 15 via the internal bus, the bus bridge 4 and the extension bus.

A VTR (Video Tape Recorder) 16 records the video and audio data outputted from the expander 15 and/or reproduces the recorded data. And a display 17 displays, when necessary, the picture outputted from the expander 15. The picture outputted from the expander 15 can be displayed also by a TV (Television) monitor in addition to the display 17 of the computer.

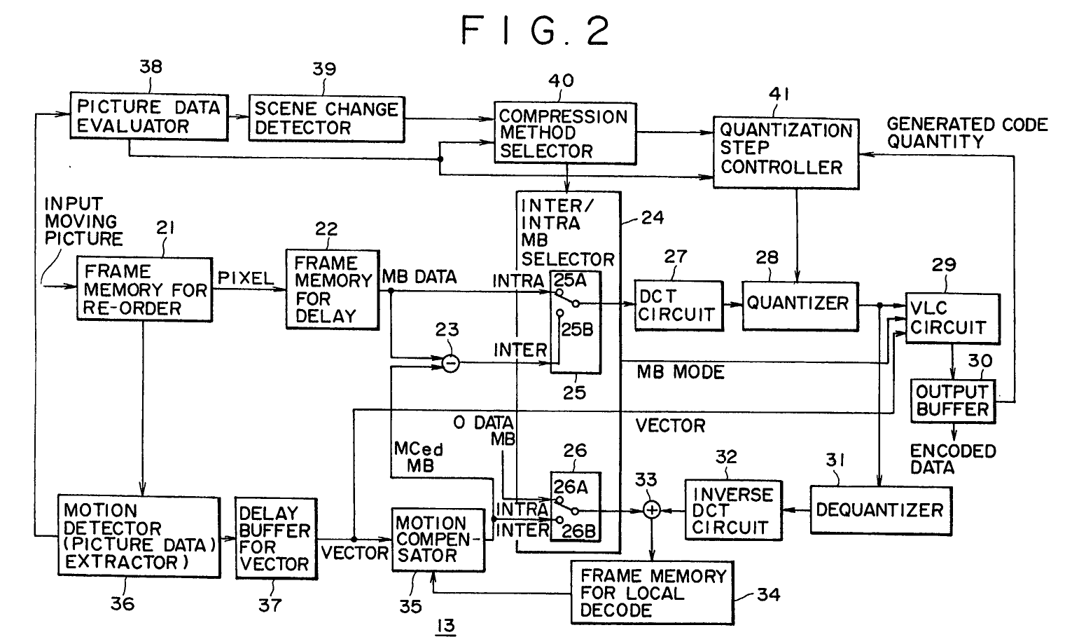

FIG. 2 shows a structural example of the hardware of the compressor 13 in FIG. 1.

In the embodiment of FIG. 2, the compressor 13 is so contrived as to encode pictures in conformity with the MPEG (Moving Picture Experts Group) standard for example.

More specifically, the picture received by the tuner 5 or the modem 6, or the picture picked up by the video camera 14, or the picture reproduced by the VTR 16, is supplied to a frame memory 21 as picture (moving picture) data to be encoded. The frame memory 21 has a capacity of storing picture data of several frames (or fields), and stores such data therein after rearranging, when necessary, the frames of the input picture data. That is, the picture data of each frame is processed as an I-picture, a P-picture or a B-picture. However, there may exist a case where, for example, the processing of a B-picture requires an I-picture or a P-picture which is temporally posterior thereto, so that the I-picture or the P-picture needs to be processed prior to the B-picture. Therefore, in the frame memory 21, the frames are so rearranged that the temporally posterior frame can be processed first.

Each picture of the frames inputted sequentially is processed as an I-, P- or B-picture in accordance with a predetermined program.

The picture data rearranged in the frame memory 21 are outputted to a frame memory 22 in the next stage. In the frame memory 22, the picture data from the frame memory 21 are delayed by a time corresponding to several ten frames (e.g., 60 frames) and then are outputted in units of macro block. Each macro block thus outputted from the frame memory 22 is supplied to a calculator 23 while being supplied also to an MB (macro block) selector (inter/intra MB selector) 24.

Meanwhile a motion detector 36 detects, in units of macro block, the motion vector of each picture stored in the frame memory 21.

Referring to a predetermined reference frame, the motion detector 36 executes pattern matching (block matching) of the reference frame and the macro block of the frame supplied from the frame memory 21 to the frame memory 22, thereby detecting the motion vector of the macro block.

In the MPEG standard, there are four encoding modes for predicting the motions of pictures, i.e., an intra encoding (intra-frame encoding) mode, a forward predictive encoding mode, a backward predictive encoding mode, and a bidirectional predictive encoding mode. An I-picture is processed in an intra encoding mode; a P-picture is processed in an intra encoding mode or a forward predictive encoding mode; and a B-picture is processed in an intra encoding mode, a forward predictive encoding mode, a backward predictive encoding mode, or a bidirectional predictive encoding mode.

Regarding an I-picture, the motion detector 36 extracts merely the picture data without detecting the motion vector thereof. More specifically, the motion detector 36 has, in addition to its essential function of detecting the motion vector, another function to serve as a picture data extractor which extracts the picture data for evaluating the picture. For example, the motion detector 36 calculates the dispersion of an I-picture in units of macro block and then outputs the result as picture data to a picture data evaluator 38.

Regarding a P-picture, the motion detector 36 executes a forward prediction to detect the motion vector thereof. Further the motion detector 36 calculates the prediction error derived from such forward prediction (absolute-value sum or square sum of the difference between mutually corresponding pixels in the macro block to be encoded and the reference frame portion which matches most with that macro block) and the dispersion of the macro block to be encoded (i.e., macro block of the P-picture), and then outputs such picture data to the picture data evaluator 38. Subsequently the motion detector 36 outputs the detected motion vector via a delay buffer 37 to a VLC (variable length coding) circuit 29 and a motion compensator 35. In this stage, the delay buffer 37 delays the output motion vector of the motion detector 36 by a time equal to the delay in the frame memory 22.

And regarding a B-picture, the motion detector 36 executes a forward prediction, a backward prediction and a bidirectional prediction to detect the motion vector in each prediction. Thereafter the motion detector 36 calculates the prediction error derived from each of such forward prediction, backward prediction and bidirectional prediction, and also the dispersion of the macro block to be encoded (i.e., macro block of the B-picture), and then outputs such picture data to the picture data evaluator 38. Further the motion detector 36 outputs the detected motion vector via the delay buffer 37 to the VLC circuit 29 and the motion compensator 35.

Upon reception of the motion vector, the motion compensator 35 reads out the encoded and locally decoded picture data from the frame memory 34 in accordance with the motion vector, and then supplies the picture data as a predicted picture to the calculator 23 and the MB selector 24.

The calculator 23 calculates the difference between the macro block obtained from the frame memory 22 and the predicted picture from the motion compensator 35 (hereinafter this difference will be referred to as predictive residual). The value of this difference is supplied to the MB selector 24.

The MB selector 24 has switches 25 and 26, and the macro block outputted from the frame memory 22 and the predictive residual outputted from the calculator 23 are supplied to terminals 25A and 25B of the switch 25, respectively. Meanwhile a macro block of value 0 (0 data MB) and the predicted picture outputted from the motion compensator 35 are supplied to terminals 26A and 26B of the switch 26, respectively.

The switch 25 is controlled by a compression method selector 40, and selects the terminal 25A or 25B when the prediction mode is set to an intra encoding mode or an inter encoding mode (forward predictive encoding mode, backward predictive encoding mode, or bidirectional predictive encoding mode). Similarly the switch 26 is controlled by the compression method selector 40, and selects the terminal 26A or 26B when the prediction mode is set to an intra encoding mode or an inter encoding mode. The outputs of the switches 25 and 26 are supplied to a DCT (discrete cosine transform) circuit 27 and a calculator 33, respectively. And in accordance with the prediction mode selected by the compression method selector 40, the MB selector 24 outputs a macro block type (MB_mode), which represents a macro block processing method, to the VLC circuit 29.

In the DCT circuit 27, a DCT process is executed to the output of the switch 25, and a DCT coefficient obtained as a result of such a process is supplied to a quantizer 28. Thereafter in the quantizer 28, a quantization step (quantization scale) is set under control of a quantization step controller 41, and the DCT coefficient from the DCT circuit 27 is quantized by a value obtained through multiplication of the quantization step by the coefficient of a quantization matrix. The quantized DCT coefficient (hereinafter referred to as quantized value) is supplied to the VLC circuit 29.

Subsequently in the VLC circuit 29, the macro block type outputted from the MB selector 24, the quantized value from the quantizer 28 and the required motion vector from the delay buffer 37 are converted into variable length code such as Huffman code and then are supplied to an output buffer 30. In the VLC circuit 29, only the required one of the motion vectors outputted from the delay buffer 37 is selected on the basis of the macro block type obtained from the MB selector 24, and a VLC process is executed to the selected motion vector.

The output buffer 30 temporarily stores therein the encoded data obtained from the VLC circuit 29 and, after smoothing the data quantity, outputs the same therefrom. The encoded data are transmitted via the modem 6 or are supplied via the auxiliary storage interface 10 to the CD-R 11 or the hard disk 12 to be stored (recorded) therein. The stored data quantity in the output buffer 30 is supplied (fed back) as a generated code quantity to the quantization step controller 41.

Meanwhile the quantized value outputted from the quantizer 28 is supplied also to a dequantizer 31 in addition to the VLC circuit 29. In the dequantizer 31, the quantized value from the quantizer 28 is dequantized in accordance with the quantization step used in the quantizer 28, to be thereby converted into a DCT coefficient. The DCT coefficient thus obtained is supplied to an inverse DCT circuit 32. Subsequently in the inverse DCT circuit 32, an inverse DCT process is executed to the DCT coefficient, and then the result is supplied to the calculator 33.

In addition to the output of the inverse DCT circuit 32, the output of the switch 26 is also supplied to the calculator 33 as described, so that the calculator 33 adds such outputs to each other to locally decode the original picture. (However, when the prediction mode is set to an intra encoding mode, the switch 26 selects its terminal 26A as mentioned, and consequently a macro block of value 0 is supplied to the calculator 33. Therefore, no process is executed substantially in the calculator 33, and the output of the inverse DCT circuit 32 is delivered as it is.) The locally decoded picture obtained in the calculator 33 is the same as the decoded picture obtained on the decoder side.

The locally decoded picture obtained in the calculator 33 is supplied to a frame memory 34 to be stored therein. And subsequently, such locally decoded picture is used as a reference picture (reference frame) for generating, in the motion compensator 35, a predicted picture relative to the picture processed in an inter encoding mode (forward predictive encoding mode, backward predictive encoding mode or bidirectional predictive encoding mode).

Meanwhile in the picture data evaluator 38, the picture data from the motion detector 36 is evaluated to find the picture complexity of each frame. The picture complexity is supplied, when required, to a scene change detector 39, the compression method selector 40 and the quantization step controller 41. Also in the picture data evaluator 38, picture data are obtained with regard to each macro block of a P-picture by comparing the dispersion thereof with the prediction error derived from the forward prediction, and then the result of such comparison is also supplied, when required, to the scene change detector 39, the compression method selector 40 and the quantization step controller 41. Further in the picture data evaluator 38, with regard to each macro block of a B-picture, the least of the prediction errors derived from forward prediction, backward prediction and bidirectional prediction (hereinafter referred to as least prediction error) is detected, and the least prediction error is compared with the dispersion of the macro block to be encoded (i.e. B-picture macro block). And the result of this comparison is also supplied, when required, to the scene change detector 39, the compression method selector 40 and the quantization step controller 41.

In the scene change detector 39, a detection is performed as to the existence of any scene change on the basis of the data from the picture data evaluator 38, and the result of such detection is supplied to the compression method selector 40. Subsequently in this selector 40, one picture compression method is selected by using the data from the picture data evaluator 38 and, if necessary, the output of the scene change detector 39 as well. Regarding each macro block of an I-picture for example, the compression method selector 40 selects an intra encoding mode and then controls the MB selector 24 (switches 25 and 26) in accordance with the result of such selection.

Regarding each macro block of a P-picture for example, the compression method selector 40 sets a prediction mode on the basis of the output data obtained from the picture data evaluator 38 as a result of comparing the prediction error derived from the forward prediction with the dispersion of the macro block to be encoded. More specifically, an intra encoding mode is selected when the dispersion of the macro block is smaller than the prediction error, or a forward predictive encoding mode is selected out of an inter encoding mode when the prediction error derived from the forward prediction is smaller than the dispersion. Then the compression method selector 40 controls the MB selector 24 in accordance with the result of such selection.

Regarding each macro block of a B-picture for example, the compression method selector 40 sets a prediction mode on the basis of the output data obtained from the picture data evaluator 38 as a result of comparing the least prediction error (the least of the prediction errors derived respectively from forward prediction, backward prediction and bidirectional prediction) with the dispersion of the macro block to be encoded. More specifically, an intra encoding mode is selected when the dispersion of the macro block is smaller than the least prediction error, or a prediction mode, where the least prediction error is obtained, is selected out of an inter encoding mode when the least prediction error is smaller than the dispersion. And then the compression method selector 40 controls the MB selector 24 in accordance with the result of such selection.

The prediction mode selected in the compression method selector 40 is supplied to the quantization step controller 41. And in the motion compensator 35, the predicted picture corresponding to the prediction mode selected in the compression method selector 40 is generated through motion compensation.

In the compression method selector 40, fundamentally an inter encoding mode is selected with regard to a P-picture and a B-picture. However, there may occur a case where any image having low inter-frame correlation is generated due to a scene change or the like, and if such image is predictively encoded in an inter encoding mode, it may cause increase of the generated code quantity and deteriorate the image quality of the decoded picture.

Therefore, as mentioned, the result of detecting a scene change is supplied from the scene change detector 39 to the compression method selector 40. And in response to the result indicating the existence of a scene change, the compression method selector 40 forcibly sets the prediction mode, which is relative to the picture after the scene change, to an intra encoding mode.

The quantization step controller 41 receives, as described, both the data from the picture data evaluator 38 and the generated code quantity from the output buffer 30. And then the quantization step controller 41 controls, on the basis of such data supplied, the quantization step used in the quantizer 28.

That is, the quantization step controller 41 recognizes the stored data quantity of the output buffer 30 on the basis of the generated code quantity obtained from the output buffer 30, and then controls the quantization step in accordance with the stored data quantity in such a manner as not to cause any overflow or underflow with respect to the output buffer 30. More concretely, when the stored data quantity of the output buffer 30 approaches to its capacity and is about to cause overflow, the quantization step controller 41 increases the quantization step to thereby reduce the generated code quantity. On the contrary, when the stored data quantity of the output buffer 30 approaches to zero and is about to cause underflow, the quantization step controller 41 reduces the quantization step to thereby increase the generated code quantity.

Further the quantization step controller 41 recognizes the complexity of the picture to be encoded on the basis of the data outputted from the picture data evaluator 38, and then controls the quantization step in accordance with the complexity. It is preferred that, in view of the image quality of the decoded picture, a complicated picture is quantized at a small quantization step, while a flat picture is quantized at a large quantization step. In the quantization step controller 41, such control of the quantization step is executed in accordance with the complexity of each picture.

It is desired that an assigned bit quantity to each picture be determined on the basis of the picture complexity as viewed from a point of improving the image quality of the decoded picture. However, due to the problem of a bit rate, it is necessary to take the generated code quantity also into consideration in addition to the picture complexity. For this reason, as described, the quantization step controller 41 is so contrived as to control the quantization step, which is used in the quantizer 28, on the basis of both the data from the picture data evaluator 38 and the generated code quantity obtained from the output buffer 30.

However, if the complexity of merely the picture to be encoded is taken into consideration, there arises a problem that, when any complicated picture is generated suddenly after succession of flat pictures, the bit quantity assigned to the complicated picture needs to be increased for improving the image quality. In this case, if the encoded data quantity stored in the output buffer 30 is close to the capacity thereof, it is impossible to increase the assigned bit quantity for the complicated picture due to the necessity of preventing overflow of the output buffer 30. Consequently, the image quality of the decoded picture is deteriorated.

On the contrary, when a flat picture is generated suddenly after succession of complicated pictures, the bit quantity assigned to the flat picture needs to be reduced for improving the image quality. In this case, if the encoded data is not stored substantially in the output buffer 30, it is impossible to reduce the assigned bit quantity for the flat picture due to the necessity of preventing underflow of the output buffer 30. In this case also, the image quality of the decoded picture is deteriorated.

For the purpose of solving the above problems, the embodiment of FIG. 2 is so contrived that the picture data are encoded after being delayed for a considerable period of time in the frame memory 22, whereby the picture data of successive frames corresponding to such a delay time, and also the complexities thereof, can be obtained in the picture data evaluator 38. More specifically, it is possible to obtain, in addition to the complexity of the relevant picture to be encoded, the complexities of successive pictures of subsequent several to several ten frames to be encoded thereafter. In this case where the complexities of ensuing pictures to be encoded later are also taken into consideration, proper bit assignment is achievable as viewed from both points of improving the image quality of each picture and preventing underflow and overflow of the output buffer 30.

The complexity of a picture reflects the generated code quantity thereof. Accordingly, a recognition of the complexity of any picture to be encoded in the future signifies a prediction of the generated code quantity of the relevant picture. A return of the actual generated code quantity obtained from the output buffer 30 can be regarded as feedback, whereas a prediction of the generated code quantity can be regarded as feedforward. In this sense, the compressor 13 shown in FIG. 2 is considered as a feedforward type MPEG video encoder.

In the nonlinear editing apparatus of FIG. 1, pictures received by the tuner 5 or the modem 6, those picked up by the video camera 14, or those reproduced by the VTR 16 are encoded by the compressor 13, and the encoded data are stored in the hard disk 12 or the like to be ready for nonlinear editing. And when the compressor 13 executes such encoding, the compressor 13 is controlled by the microprocessor 1 so that special effects can be simply exerted on the pictures.

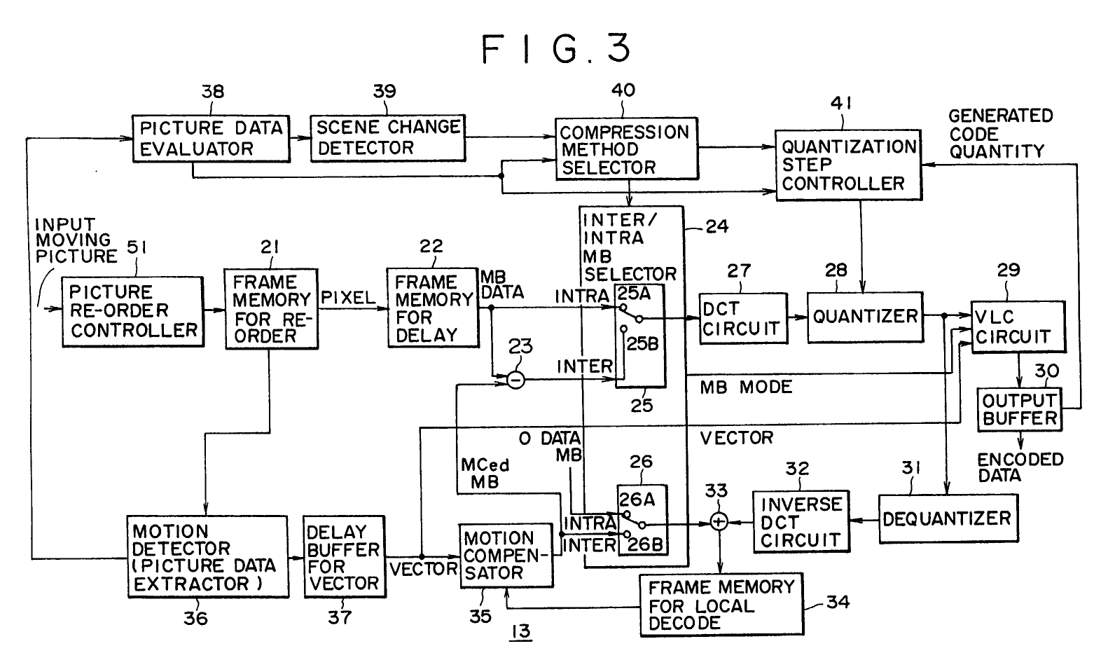

FIG. 3 shows a first functional structural example of the compressor 13 which exerts special effects on a picture. In this diagram, any component circuits or elements corresponding to those in FIG. 2 are denoted by like reference numerals, and a repeated explanation thereof will be omitted in the following description.

In the embodiment of FIG. 3, the compressor 13 is structurally the same as the foregoing embodiment of FIG. 2 with the exception that a picture re-order controller 51 is additionally provided in the preceding stage of a frame memory 21. For example, the picture re-order controller 51 is realized by software as a microprocessor 1 executes an application program for special effects, so as to manipulate the sequence of frames inputted to the compressor 13.

In the compressor 13 of the structure mentioned above, a picture to be encoded is inputted and then is supplied to the picture re-order controller 51. Normally this controller 51 outputs the supplied picture directly to the frame memory 21 in the next stage. However, in case the time code attached to the relevant picture is coincident with the preset time code, the sequence of frames supplied thereto is manipulated for a preset time prior to being outputted.

More specifically, in exerting special effects to manipulate the frame sequence, a user presets, by means of a keyboard 8 or a mouse 9, a sequence manipulation method, a preset time code of the frame to start manipulation of such sequence, and a preset time to execute the manipulation. After completion of such presetting operation, the picture re-order controller 51 executes its control action in a manner that, when the time code attached to the supplied picture is coincident with the preset time code, the sequence of the supplied frame is manipulated for the preset time.

Concretely, for example, the frames are re-ordered to be in a temporally reverse arrangement. In another example, frames are partially eliminated at a rate of one frame (or several frames) per predetermined number, and the preceding frame is copied at the position of the eliminated frame (so that the total number of frames remains unchanged).

In this case, special effects can be so exerted as to give impression of reverse reproduction or partial elimination of the pictures.

In the above embodiment, the picture re-order controller 51 is positioned in the preceding stage of the frame memory 21. However, this controller 51 may be positioned posterior to the frame memory 21 (i.e., anterior to the frame memory 22) or posterior to the frame memory 22 as well.

Further, the picture re-order controller 51 is realizable by manipulating the sequence of the frames stored in the frame memory 22 for example.

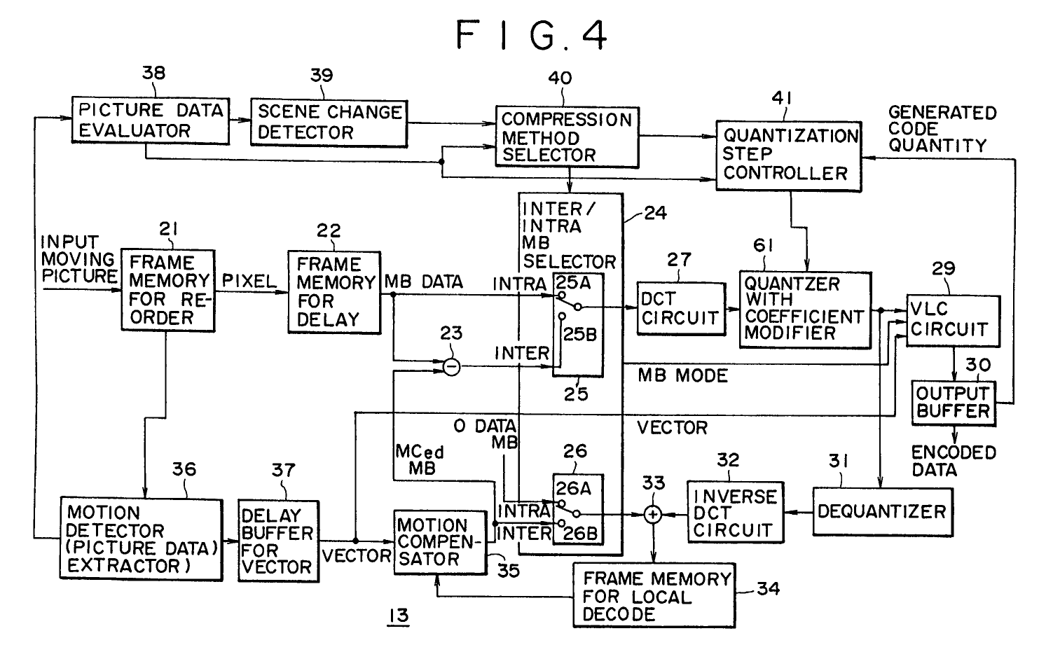

FIG. 4 shows a second functional structural example of the compressor 13 which exerts special effects on a picture. In this diagram, any component circuits or elements corresponding to those in FIG. 2 are denoted by like reference numerals, and a repeated explanation thereof will be omitted in the following description.

In the embodiment of FIG. 4, the compressor 13 is structurally the same as the foregoing embodiment of FIG. 2 with the exception that a quantizer (with a coefficient modifier circuit) 61 is provided instead of the aforementioned quantizer 28. Fundamentally this quantizer 61 functions in the same manner as the quantizer 28 of FIG. 2, and further serves to manipulate (modify) the DCT coefficient, which is obtained from a DCT circuit 27, under control of an application program executed by a microprocessor 1 for special effects.

In the compressor 13 of the above structure, normally the quantizer 61 quantizes a DCT coefficient supplied thereto and then outputs the same similarly to the aforementioned quantizer 28 of FIG. 2. However, when the time code attached to the relevant picture is coincident with the preset time code, the quantizer 61 modifies the supplied DCT coefficient until a lapse of the preset time and then outputs the modified coefficient.

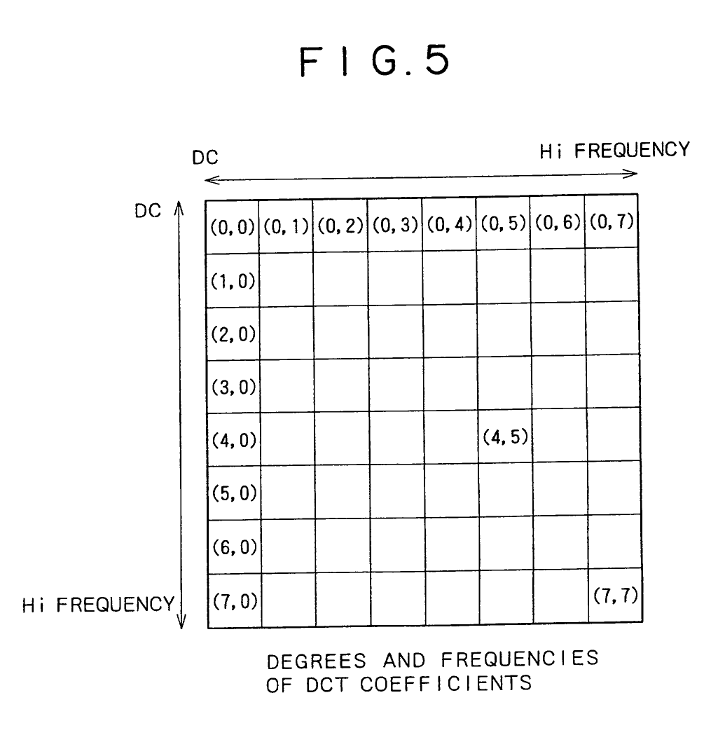

More specifically, DCT coefficients are supplied to the quantizer 61 per block of 8×8 pixels as shown in FIG. 5 for example. And out of such 8×8 DCT coefficients, merely the DC (direct current) component (left uppermost DCT coefficient) is quantized normally, while 0 is outputted with regard to each of the remaining DCT coefficients. The quantizer 61 executes such quantization only in an intra encoding mode, and outputs 0, in an inter encoding mode, with regard to the DC component as well. Further the quantizer 61 quantizes the entire DCT coefficients normally and, when outputting the result of the quantization through zigzag scan or alternate scan, delivers the result as it is relative to a first predetermined number, an intermediate predetermined number, or a last predetermined number without any change, while delivering 0 relative to each of the other DCT coefficients.

In the quantizer 61, it is also possible to prepare, separately from the ordinary quantization matrix used for normal quantization, another quantization matrix of a greater value which is capable of outputting 0 relative to a DCT coefficient corresponding, out of the entire quantization matrix coefficients, to the position where 0 or a negative number is set, or outputting a result of the normal quantization relative to any other DCT coefficient, or limiting the DCT coefficient. In this case, the quantizer 61 can output 0 relative to any DCT coefficient quantized as 0 by the latter quantization matrix of a greater value, or output the result of the normal quantization relative to any other DCT coefficient.

For example, when only the DC component in the entire DCT coefficients is normally quantized while 0 is outputted with regard to each of the remaining coefficients, the relevant block of 8×8 pixels is given merely a single color, so that the picture can be covered with a mosaic or the like in this case. In another example, a mosaic can be effected by executing normal equalization of only the DC component in an intra encoding mode, or by outputting 0 with regard to the DC component also in an inter encoding mode. It is further possible to increase mosaic variations by manipulating the macro block type in an inter encoding mode to perform no MC (motion compensation) in the case of a P-picture, or by manipulating the motion vector to set its value to 0 (i.e., to set the motion vector to (0, 0)) in the case of a B-picture.

In a further example, special effects of processing a picture through low-pass filtering are achievable when outputting only the first predetermined number of the 8×8 quantization results directly. Moreover, special effects of processing a picture through high-pass filtering are also achievable when outputting only the last predetermined number of the 8×8 pixel quantization results directly. In another example, more complicated special effects can be exerted by executing such DCT coefficient manipulation merely in an inter encoding mode alone while not executing such manipulation in an intra encoding mode.

It is also possible to exert special effects on either entire or partial frames by manipulation of the DCT coefficients.

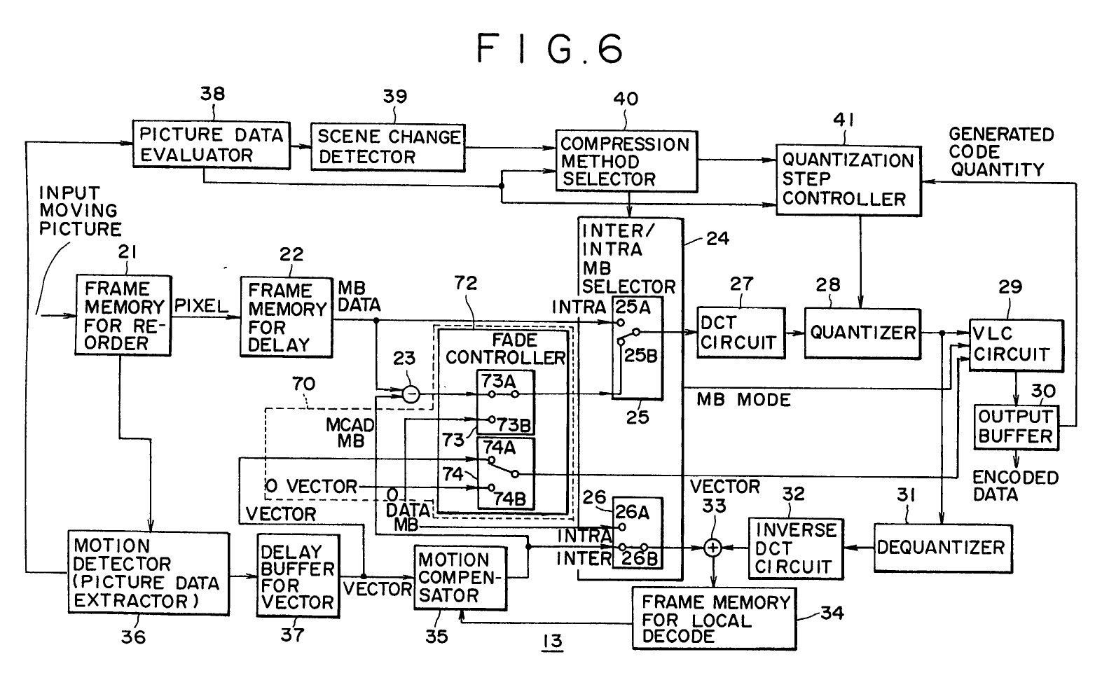

FIG. 6 shows a third functional structural example of the compressor 13 which exerts special effects on a picture. In this diagram, any component circuits or elements corresponding to those in FIG. 2 are denoted by like reference numerals, and a repeated explanation thereof will be omitted in the following description.

In the embodiment of FIG. 6, a mosaic fader 70 is additionally provided. For example, the mosaic fader 70 comprises a fade controller 72 and is realized as a microprocessor 1 executes an application program for special effects. The fade controller 72 consists of switches 73 and 74. The switch 73 selects a signal supplied to either a terminal 73A or 73B thereof and then delivers the signal to a terminal 25B of a switch 25, while the switch 74 selects a signal supplied to either a terminal 74A or 74B thereof and then delivers the signal to a VLC circuit 29. In this embodiment, an output of a calculator 23 is supplied to the terminal 73A, while a macro block of a value 0 (hereinafter referred to as 0 macro block) is supplied to the terminal 73B. And a motion vector outputted from a motion detector 36 via a delay buffer 37 is supplied to the terminal 74A, while a motion vector of a magnitude 0 (hereinafter referred to as 0 vector) is supplied to the terminal 74B.

In the embodiment of FIG. 6, the operation of an MB selector 24 is performed under control of both a compression method selector 40 and a microprocessor 1.

In the compressor 13 of the above structure, selection of data in the MB selector 24, picture data and motion vector to be inputted to the DCT circuit 27 are so manipulated as to exert special effects on the picture. Due to such manipulation at a scene change for example, special effects can be exerted to execute mosaic fade which applies a mosaic per macro block with gradual change of scenes from a preceding image to a succeeding image.

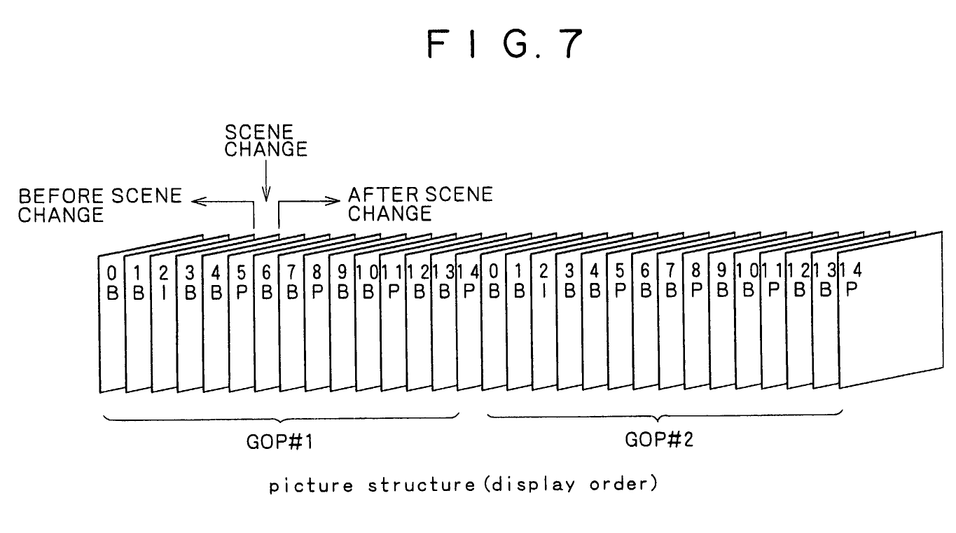

Suppose now that, as shown in FIG. 7 for example, a GOP (Group of Pictures) is constituted of 15 frames as a unit with regard to the relevant image to be encoded. In FIG. 7, the type of each picture signifying an I-picture, a P-picture or a B-picture is denoted by a capital alphabet letter I, P or B, and the display order of pictures constituting each GOP is denoted by sequential numerals beginning with 0. In the following description, the nth picture from the top of each GOP will be expressed with attachment of n−1 to the picture type. Accordingly, in FIG. 7, the fourth frame for example from the top of each GOP is B3.

Assume here that a scene change has occurred between I2 and B3 in GOP #1 composed as shown in FIG. 7. In this case, the time code of frame B3 immediately after the scene change and the time corresponding to the number N of frames for special effects are preset respectively. Then in the compressor 13, frames B3, B4, P5, B6, B7, . . . posterior to the scene change appear gradually more, in units of macro blocks, on frame I2 immediately anterior to the scene change, and the entire pictures after N frames from B3 are so encoded as to be displayed instead of I2.

In order to start such mosaic fade of picture I2 at the timing of displaying B3 and to complete the fade after a lapse of N frames, the picture I2 is frozen and the quantity of displaying the picture of each frame on I2 is increased by 1/N frame. More specifically, with regard to B3, its 1/N frame is encoded normally while the remaining (N−1)/N frame thereof is so encoded that I2 is decoded. Further regarding B4, its 2/N frame is encoded normally while the remaining (N−2)/N frame thereof is so encoded that I2 is decoded. Regarding P5, its 3/N frame is encoded normally while the remaining (N−3)/N frame thereof is so encoded that I2 is decoded. Subsequently, similar encoding is executed to achieve the mosaic fade which is completed after a lapse of N frames.

Therefore, when encoding P5 in the compressor 13 after encoding B0 and B1 subsequently to I2 (in case each GOP is so composed as shown in FIG. 7, it is encoded in the order of I2, B0, B1, P5, B3, B4, P8, B6, . . . ), the 3/N frame of P5 is encoded normally. That is, in the fade controller 72, the terminals 73A and 74A are selected in the switches 73 and 74, respectively. And the same processing as described in connection with FIG. 2 is executed in the MB selector 24. As a result, the 3/N frame of P5 is encoded normally. In this case, P5 is encoded with reference to I2. However, since I2 and P5 are pictures before and after the scene change respectively, it is presumed that fundamentally the 3/N frame of P5 is encoded in an intra encoding mode.

Further in the compressor 13, the remaining (N−3)/N frame of P5 is so encoded that I2 is decoded. More specifically, in the fade controller 72, the terminals 73B and 74B of the switches 73 and 74 are selected respectively. And in the MB selector 24, the terminals 25B and 26B of the switches 25 and 26 are selected respectively. And in the MB selector 24, the macro block type need not be encoded (i.e., since the predictive residual is 0, the DCT coefficients need not be encoded). In this case, the switch 73 outputs a 0 macro block, which is then supplied via the MB selector 24 to the DCT circuit 27. Meanwhile the switch 74 otputs a 0 vector, which is then supplied to the VLC circuit 29. Further the macro block type, which need not be encoded, is supplied to the VLC circuit 29. Consequently, the (N−3)/N frame of P5 is encoded in an inter encoding mode with both the predictive residual and the motion vector being set to 0, so that the reference picture relative to the (N−3)/N frame, i.e., I2 in this case, is decoded in the decoder.

After completion of encoding P5, the same encoding is performed with regard to B3, B4, P8, B5, . . . and so forth at the foregoing rate in such a manner that some portions thereof are encoded normally while the remaining portions are so encoded that I2 is decoded.

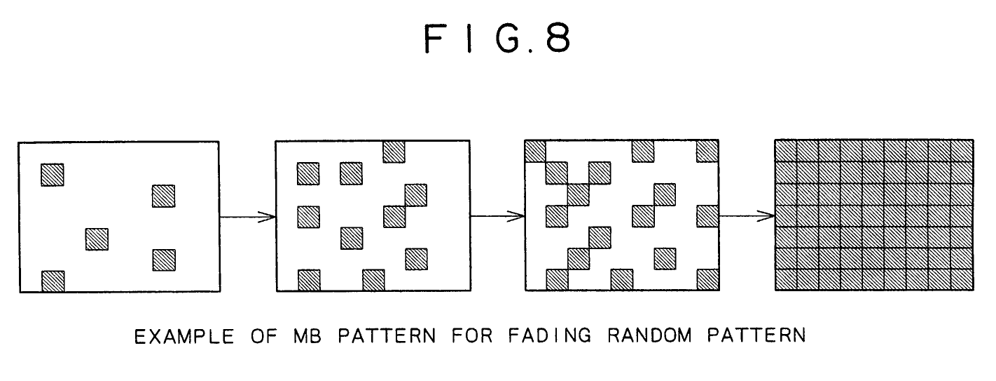

If the portions (macro blocks) to be encoded normally are increased in a raster scanning order for example, there is executed a mosaic fade where the macro blocks after a scene change appear gradually more in the raster scanning order. Meanwhile, if the portions to be encoded normally are increased at random, there is executed another mosaic fade (random fade) where the macro blocks after a scene change (e.g., portions shown with oblique lines in FIG. 8) appear gradually more at random.

The method of actuating the switches 25 and 26 or 73 and 74 is not limited to the aforementioned example alone, and any other pertinent method may also be adopted to achieve more complicated special effects.

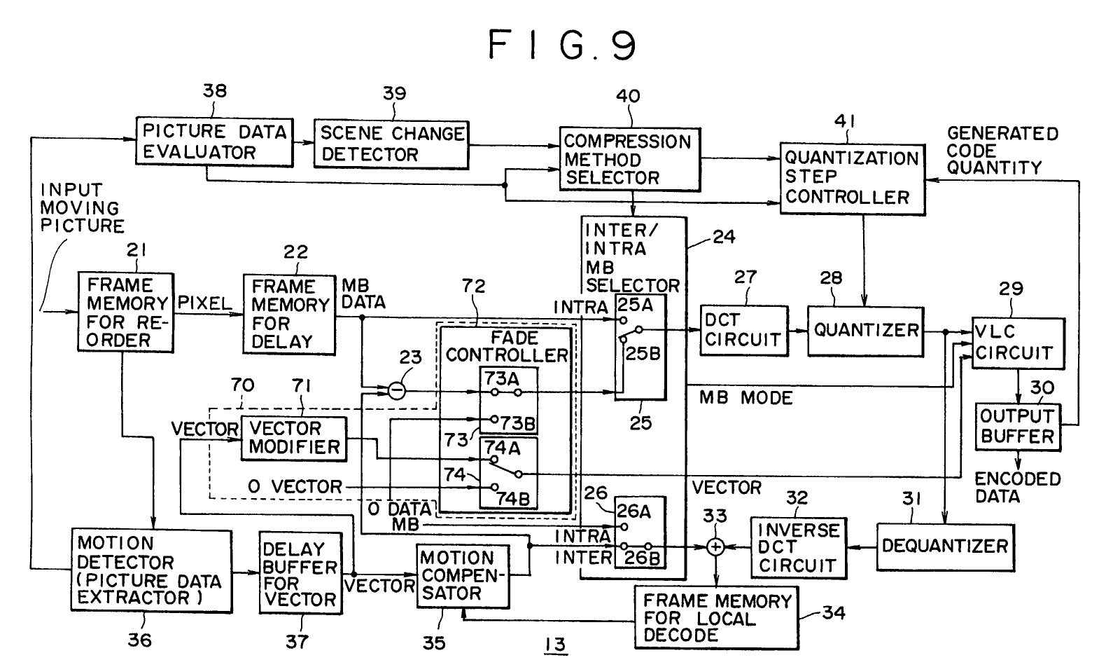

FIG. 9 shows a fourth functional structural example of the compressor 13 which exerts special effects on a picture. In this diagram, any component circuits or elements corresponding to those in FIG. 6 are denoted by like reference numerals, and a repeated explanation thereof will be omitted in the following description.

In the embodiment of FIG. 9, a vector modifier 71 is additionally provided in a mosaic fader 70. For example, the vector modifier 71 is realized as a microprocessor 1 executes an application program for special effects, and it is capable of modifying the magnitude and direction of the motion vector outputted from a motion detector 36 via a delay buffer 37.

In the compressor 13 of the structure mentioned, a motion vector is so modified, by the vector modifier 71, as to be oriented in a predetermined direction (e.g., upward, downward, leftward, rightward, or toward the center of frame), or its magnitude is modified at a predetermined rate. Consequently, it becomes possible to achieve special effects of causing flow of the entire picture in a predetermined direction, or special effects of lowering or raising the motion speed.

Due to such control of the compressor 13 in a manner to exert special effects on pictures, it is not particularly necessary to add any hardware to the compressor 13, and exertion of special effects can be attained simply by adding or modifying a program which is executed by the microprocessor 1 (e.g., a control program in case the compressor 13 is formed into an IC (integrated circuit) and its control is performed by the microprocessor 1). And the processing required for exertion of special effects is merely to change the sequence of pictures to be encoded, or to manipulate (modify) some parameters (MPEG parameters) such as DCT coefficients, macro block types and motion vectors included in the data encoded in conformity with the MPEG standard, so that desired special effects are achievable only by a light-load process executed in a short period of time.

In the compressor 13 serving as a feed forward type MPEG video encoder explained in connection with FIG. 2, a picture is delayed by a considerable time (e.g., 1 or 0.5 second) in the frame memory 22. Therefore, special effects exerted by controlling a subsequent stage posterior to the frame memory 22 can be indicated by a user who watches the picture inputted to the compressor 13. That is, in the aforementioned case, the time code of the frame at the start point of special effects is preset in advance. However, besides this example, the picture being inputted to the compressor 13 may be visually represented on the display 17, and the user may indicate the frame at the start point of special effects while watching the displayed picture. Since the relevant frame is still stored in the frame memory 22, special effects can be started from that frame. (In contrast therewith, if the frame memory 22 is not existent, it is difficult to exert the aforementioned real-time pecial effects when the user indicates the frame at the start point of special effects, because the relevant frame has already been encoded.)

The picture re-order controller 51, the quantizer 61 and the mosaic fade controller 70 mentioned above may be provided individually, or two or more of them may be provided as well.

In the embodiments described above, special effects are exerted on a picture when it is encoded in the compressor 13. Moreover, it is also possible to exert special effects on the picture by manipulating the parameters (MPEG parameters) included in the data encoded by the compressor 13.

Suppose now that the keyboard 8 or the mouse 9 is manipulated by the user to preset a time code, a time and a kind of special effects to be exerted on a desired picture, and a command is outputted to exert special effects of the preset kind. And further suppose that the encoded data obtained by encoding the desired picture for special effects is already stored in the hard disk 12 for example.

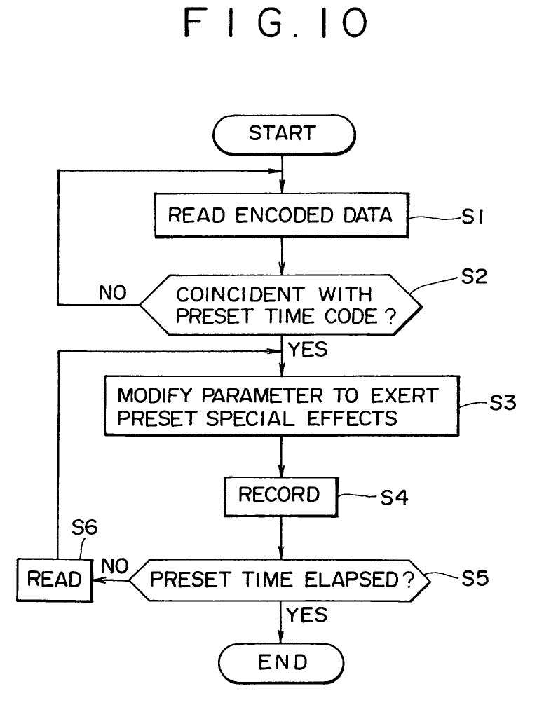

In this case, a processing routine shown in a flowchart of FIG. 10 for example is executed in the microprocessor 1.

First at step S1, encoded data corresponding to one frame for example are read out, and then the processing proceeds to step S2, where a decision is made as to whether the time code of the picture of the encoded data read out at step S1 is coincident with the preset time code. And if the result of this decision signifies no coincidence, the processing returns to step S1 where encoded data corresponding to the next frame are read out.

In the data encoded in conformity with the MPEG standard, the time code is described merely per GOP, but the time code of each frame (picture) can be inferred from the time code described per GOP and a temporal reference.

If the result of the decision at step S2 signifies that the time code of the picture corresponding to the encoded data read out at step S1 is coincident with the preset time code, the processing proceeds to step S3, where required parameters for exerting the preset special effects are manipulated out of the DCT coefficients, macro block types and motion vectors included in the encoded data.

For example, the DCT coefficients except the DCcomponent are set to 0, or the motion vector is set to 0, as described.

Subsequently the processing proceeds to step S4, where the encoded data obtained by manipulating the parameters is overwritten at the position of the former encoded data.

Such special effects achieved by manipulating the parameters fundamentally cause reduction of the quantity of the encoded data (i.e., cause no increase of the data quantity), so that the encoded data obtained by manipulation of the parameters can be overwritten at the position of the former encoded data, or the encoded data can be partially replaced. Since the encoded data quantities before and after manipulation of the parameters need to be equal to each other, stuffing bits for example are written to compensate for any insufficiency of the data quantity.

After the encoded data are thus written, the processing proceeds to step S5, where a decision is made as to whether the preset time has elapsed or not subsequently to a coincidence of the time code with the preset time code. And if the result of this decision at step S5 signifies that the preset time has not yet elapsed, the processing proceeds to step S6 to read out the encoded data corresponding to the next frame, and then the processing returns to step S3. In this case, therefore, the parameters relative to the encoded data of the next frame are manipulated.

Meanwhile, if the result of the decision at step S5 signifies a lapse of the preset time, the entire processing is completed.

As mentioned above, special effects including application of mosaic, mosaic fade and so forth can be exerted simply by mere manipulation of the parameters of encoded data without the necessity of decoding even the pixel data of the raster image of the encoded data.

In each of the embodiments, the component blocks (FIG. 2) for encoding data according to the MPEG standard are constituted of hardware, while the other blocks for exerting special effects are constituted of software. On the contrary, however, the component blocks for encoding data according to the MPEG standard may be constituted of software, while the other blocks for exerting special effects may be constituted of hardware. In another modification, both the blocks for encoding data according to the MPEG standard and the blocks for exerting special effects may be constituted of either hardware or software.

Further in the embodiments mentioned, pictures are encoded in conformity with the MPEG standard. However, the picture encoding system is not limited to the MPEG standard alone.

Although the present invention has been described hereinabove with reference to some preferred embodiments thereof, it is to be understood that the invention is not restricted to such embodiments, and a variety of other changes and modifications will be apparent to those skilled in the art without departing from the spirit of the invention.

The scope of the invention, therefore, is to be determined solely by the appended claims.

What is claimed is:

1. A picture processing apparatus for exerting special effects on a picture, comprising:
a means for encoding the picture to generate encoded data thereof; and
a means for controlling said encoding means in a manner to exert special effects on the picture.

2. The picture processing apparatus according to claim 1, wherein said control means manipulates the sequence of pictures to be encoded by said encoding means.

3. The picture processing apparatus according to claim 1, wherein, when said encoding means executes discrete cosine transform (DCT) of the picture to generate DCT coefficients, said control means manipulates such DCT coefficients.

4. The picture processing apparatus according to claim 1, wherein, when said encoding means selectively encodes either the data of the picture or the data of the difference between said picture and its predicted picture, said control means manipulates selection of the data performed by said encoding means.

5. The picture processing apparatus according to claim 1, wherein, when said encoding means selectively encodes either the data of the picture or the data of the difference between said picture and its predicted picture, said control means sets the difference between said picture and its predicted picture to zero.

6. The picture processing apparatus according to claim 1, wherein, when said encoding means detects and encodes the motion vector of the picture, said control means manipulates the motion vector thereof.

7. The picture processing apparatus according to claim 6, wherein said control means sets the magnitude of said motion vector to zero.

8. A picture processing method for exerting special effects on a picture, comprising the step of:
controlling an encoding means, which encodes the picture to generate encoded data thereof, in a manner to exert special effects on the picture.

9. A recording medium wherein a program is recorded for enabling a computer to execute a special effect process by the method defined in claim 8.

10. A picture processing apparatus for exerting special effects on a picture, comprising:
a means for manipulating a predetermined parameter, which is included in the data obtained by encoding the picture, in a manner to exert special effects on said picture.

11. The picture processing apparatus according to claim 10, wherein, when the encoded data are those obtained by executing discrete cosine transform (DCT) of the picture to generate DCT coefficients, said manipulating means manipulates such DCT coefficients.

12. The picture processing apparatus according to claim 10, wherein, when the encoded data are those obtained by selectively encoding either the data of the picture or the data of the difference between said picture and its predicted picture, said manipulating means sets the difference between said picture and its predicted picture to zero.

13. The picture processing apparatus according to claim 10, wherein, when the encoded data are those obtained by encoding the picture through detection of the motion vector thereof, said manipulating means manipulates said motion vector.

14. The picture processing apparatus according to claim 13, wherein said manipulating means sets the magnitude of said motion vector to zero.

15. A picture processing method for exerting special effects on a picture, comprising the step of:
manipulating a predetermined parameter, which is included in the encoded data of the picture, in a manner to exert special effects on said picture.

16. A recording medium wherein a program is recorded for enabling a computer to execute a special effect process by the method defined in claim 15.
